(19) United States
(12) Patent Application Publication
(10) Pub. No.: US 2025/0337794 A1
(43) Pub. Date: Oct. 30, 2025

(54) CONNECTION MANAGEMENT ENGINE IN A CLOUD ACCESS MANAGEMENT SYSTEM

(71) Applicant: Microsoft Technology Licensing, LLC, Redmond, WA (US)

(72) Inventors: Sandeep PATNAIK, Kirkland, WA (US); Rinku Khemchand DALWANI, Kirkland, WA (US); Saud Ibrahim AI-MISHARI, Snoqualmie, WA (US); Vladimir Kostadinov STOYANOV, Redmond, WA (US); Jayashree SADAGOPAN, Issaquah, WA (US); Gustavo Hernando CATALANO FONSECA, Redmond, WA (US)

(21) Appl. No.: 18/651,325

(22) Filed: Apr. 30, 2024

(51) Int. Cl. H04L 65/1069; G06F 9/455

(52) U.S. Cl. CPC H04L 65/1069; G06F 9/45558; G06F 2009/45579; G06F 2009/45595

(57) ABSTRACT

Methods, systems, and computer storage media for providing connection management using a connection management engine of a cloud access management system are described. The connection management engine operates based on local client pre-connect connections, and remote client pre-graphics operations and graphics operations to reduce connection times for remote client sessions. In operation, a request to launch a remote client is received, the request associated with a local client. A determination is made whether the local client is associated with a connected state, an express connection state, or a disconnected state. The express connection state is identified from the following: a pre-connect connection state; and cloned network context state. A determination is made that the local client is associated with the express connection state. Based on determining that the local client is associated the express connection state, a remote client session is established between the remote client and the local client.

### BACKGROUND

Users rely on computing environments with applications and services to accomplish computing tasks. Distributed computing systems and/or cloud computing platforms host and support different types of applications and services in managed computing environments. In particular, a cloud computing platform can implement a cloud access management system that provides access management functionality for different types of cloud computing offerings. For example, a cloud access management system can provide local clients access to remote clients-including managed desktop services that include virtual machines assigned to individual users as virtual desktop devices configured with productivity, security, and collaboration tools.

### SUMMARY

Various aspects of the technology described herein are generally directed to systems, methods, and computer storage media for, among other things, providing express connection management using a connection management engine of a cloud access management system. Cloud access management supports access management operations for providing remote client sessions between local clients and remote clients to enable users to seamlessly access cloud-based resources. The connection management engine operates based on a pre-connect connection that is an active lightweight connection at a local client that enables express connection management. Alternatively or additionally, the connection management engine also operates based on cloning a network context from a first local client that has an active remote client session, in order to expedite configuring a remote client session for a second local client-the first local client and the second local client are associated with the same user. Alternatively or additionally, the connection management engine further operates based on a predefined set of operations (e.g., pre-graphics operations, graphics operations, and peripheral operations) that are strategically executed at remote clients to reduce connection times of local clients to remote clients. In this way, the connection management engine can operate to enable local clients to more efficiently (e.g., instantly and timely) connect to remote clients and other cloud-based resources.

The connection management engine can refer to a component that enables express connections to cloud-based resources based on connection management resources (e.g., operations, interfaces, and data). The connection management engine provides different types of connection management operations (e.g., local-client operations, connection-service operations, remote-client operations) for reduced connection times and improved performance for remote client sessions. The local-client operations are associated with user and local client-initiated signaling; the connection-service operations are associated with connection service-initiated signaling; and the remote-client operations are associated with the remote-client-initiated signaling. The connection management engine can support remote connections and remote client sessions between local clients and remote clients associated with different states including a connected state, an express connection state (e.g., having a pre-connect connection or able to retrieve a cloned network context) and a disconnected state. The connection management engine can further support multiple local clients accessing a single remote client session; active and inactive connections to remote clients; and different scenarios for local clients, the connection service, and remote clients.

Conventionally, cloud access management systems are not configured with a comprehensive computing and logic and infrastructure to efficiently provide instant and timely connectivity to cloud-based resources. For example, the communications protocols that are used for connecting local clients to remote clients can introduce overhead, which in turn can slow down connection times. Connection session establishment can also cause delays because each connection attempt requires additional overhead to establish the new session. For example, the connecting clients may need to negotiate session parameters or perform other operations that prolong the connection process. This overhead can become particularly significant in scenarios where frequent connection attempts are made. As such, a connection management solution is necessary to ensure improved performance for computing functionality and user satisfaction associated with reduced connection times of local clients to remote clients.

A technical solution—to the limitations of conventional cloud access management systems—can include providing connection management resources via a connection management engine that enables reduced connection times and improved performance of remote client sessions. From a local client perspective, (a) a pre-connect connection state or (b) a cloned network context state can facilitate expediting connections from the local client to a remote client. In a first scenario, a local client can implement connection management resources that are associated with expediting connections based on a state of the local client. The local client can be in a pre-connect connection state based on having a pre-connect connection to a cloud computing environment of a remote client. For example, a user- or client-initiated remote client session request can leverage a pre-connect connection at a local client to connect to a remote client. The pre-connect connection can be initialized on a local client to maintain a connection to the cloud computing environment. The pre-connect connection can be established after or simultaneously with an initial connection to a remote client, or as soon as a local client has network connectivity after boot up. In this way, the pre-connect connection can be used in different instances to communicate with a remote client for establishing a remote client session.

In a second scenario, the local client may be in a cloned network context state based on a user of the local client being associated with a second local client that is connected to an existing remote client session. For example, a user- or client-initiated remote client session request can leverage a cloned network context state at a first local client to connect to a remote client. The local client may be in a cloned network context state based on a user of the local client being associated with a second local client that is connected to an existing remote client session. A determination is made that the first local client of a user is associated with a second local client of the user, the second local client having an existing remote session. The network context of the second local client is cloned and used at the first local client to establish the remote client session.

From a connection service and remote client perspective, (a) an un-finalized connection and subsequent finalized connection, or (b) an existing remote connection session can facilitate expediting connections from a local client to the remote client. In a first scenario, an un-finalized connection is generated, the un-finalized scenario being an unfinished connection that is generated based on a first set of operations (i.e., pre-graphics operations). The connection service can instruct the remote client to generate an un-finalized connection, or the remote client can generate an un-finalized connection. The unfinalized connection is maintained in a wait state until a request to establish a remote client session with the remote client is received. The request triggers generating the finalized connection for establishing the remote client session. The finalized connection is generated based on a second set of operations (i.e., graphics operations and peripheral operations).

In a second scenario, when a remote client session exists, the existing remote client session may be associated with an inactive local client. The inactive local client can be reactivated on the existing remote client thus expediting the connection process. A second local client—of a user—can also connect to an existing remote client session associated with the user and the first local client. It is further contemplated that a local client may connect to an existing remote client session based on a pre-connect connection that is configured at the local client.

As such, connection management resources can be associated with a local client, a connection service, and/or a remote client, where connection management operations can be executed independently or in combination to reduce connection times. The local client may execute connection management operations, when the remote client cannot, and vice versa; and both can execute connection management operations together. For example, the local client can be in a pre-connect connection state and use an un-finalized connection at a remote session; however, even if a pre-connect connection state does not exist at a local client, but the local client may still use an un-finalized connection or existing session at a remote client to connect to the remote client. In accordance with each of these techniques, alone or in combination, the cloud access management system can be improved based on connection management resources that operate to establish remote client sessions in an expedited manner.

In operation, in a first embodiment, a request to launch a remote client is received, the request being associated with a local client. A determination is made as to whether the local client is associated with a connected state, an express connection state, or a disconnected state. The express connection state is identified from the following: a pre-connect connection state; and cloned network context state. Based on determining that the local client is associated with the express connection state, a remote client session is established between the remote client and the local client based on the express connection state.

In a second embodiment, a status associated with a remote client is determined. The status is identified from one of the following: an existing remote client session that is not active; an existing remote client session that is active on an alternative local client; and no existing remote client session. Based on determining the status, one or more connection management operations are executed to configure an un-finalized connection using a first set of operations, the first set of operations are associated with a second set of operations that configure a finalized connection using the un-finalized connection. The first set of operations are pre-graphics operations and the second set of operations are graphics operations. Based on executing the one or more connection management operations, a remote client session is established between the remote client and a local client.

In a third embodiment, a first set of operations are executed on a remote client to configure an un-finalized connection. The first set of operations are pre-graphics operations associated with a remote client session configuration sequence that enables establishing a remote client session between the remote client and a local client. A request to establish the remote client session is received. Based on receiving the request to establish the remote client session, a second set of operations is executed to configure a finalized connection based on the un-finalized connection to establish the remote client session. The second set of operations are graphics operations associated with the remote client session configuration sequence.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is a block diagram of an exemplary cloud access management system including a connection management engine, in accordance with aspects of the technology described herein;

FIGS. 1B and 1C are connection management schematics of an exemplary cloud access management system including a connection management engine, in accordance with aspects of the technology described herein;

FIGS. 2A and 2B are flow diagrams associated with an exemplary cloud access management system including a connection management engine, in accordance with aspects of the technology described herein;

FIG. 3 provides a first exemplary method of providing connection management using a connection management engine, in accordance with aspects of the technology described herein;

FIG. 4 provides a second exemplary method of providing connection management using a connection management engine, in accordance with aspects of the technology described herein;

FIG. 5 provides a third exemplary method of providing connection management using a connection management engine, in accordance with aspects of the technology described herein;

FIG. 6 provides a block diagram of an exemplary cloud access management system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

A cloud access management system provides access management functionality for different types of cloud computing offerings. The cloud access management system can be a centralized platform designed to facilitate secure and efficient access to cloud-based resources from various devices, including traditional desktops, laptops, and thin clients. The cloud access management system can include software, hardware, and infrastructure components that enable users to authenticate, connect, and interact with remote resources hosted in the cloud. The cloud access management system manages operations associated with user identities, permissions, and access policies to ensure that only authorized users can access specific resources. Additionally, it may incorporate features such as single sign-on (SSO), multi-factor authentication (MFA), and session management to enhance security and user experience.

Conventionally, cloud access management systems are not configured with a comprehensive computing and logic and infrastructure to efficiently provide instant and timely connectivity to cloud-based resources. For example, the communications protocols that are used for connecting local clients to remote clients can introduce overhead, which in turn can slow down connection times. Connection session establishment can also cause delays because each connection attempt requires additional overhead to establish the new session. For example, the server(s) and client may need to negotiate session parameters or perform other operations that prolong the connection process. This overhead can become particularly significant in scenarios where frequent connection attempts are made.

Moreover, certain resources cannot be shared between remote client sessions, which can cause delays in connection times for establishing remote client sessions between local clients and remote clients. For example, the remote client may encounter delays as it awaits the release or completion of tasks involving exclusive resources by the local client. Subsequently, negotiation between the local client and remote client to establish compatible protocols or configurations can prolong the connection process. Additionally, if resource mapping or translation is required between the local and remote environments, additional processing time may be needed, especially for complex datasets. Mitigating these delays entails optimizing resource sharing mechanisms and minimizing latency to enhance the efficiency of remote client sessions. As such, a comprehensive cloud access management system—with an alternative basis for performing cloud access management operations—can improve computing operations and interfaces in cloud access management systems.

Embodiments of the present technical solution are directed to systems, methods, and computer storage media for, among other things, providing express connection management using a connection management engine of a cloud access management system. Cloud access management supports access management operations for providing remote client sessions between local clients and remote clients to enable users to seamlessly access cloud-based resources. The connection management engine operates based on a pre-connect connection that is an active lightweight connection at a local client that enables express connection management. The connection management engine also operates based on a predefined set of operations (e.g., pre-graphics operations, graphics operations, and peripheral operations) that are strategically executed at remote clients to reduce connection times of local clients to remote clients. In this way, the connection management engine can operate to have local clients more efficiently (e.g., instantly and timely) connect to remote clients and other cloud-based resources. Connection management is provided using the connection management engine that is operationally integrated into the cloud access management system. The cloud access management system supports a connection management framework of computing components associated with configuration and employing pre-connection connections, un-finalized connections, and/or pre-existing remote client sessions.

At a high level, a connection management engine provides local client operations, remote client operations, and connection service operations that support the functionality associated with express connection management. For example, the connection management engine can provide an agent (e.g., software agent, subsystem, or module) that carries out computations or tasks on the local client, the remote client, and/or the connection service. Express connection management can refer to process for managing connections for remote client sessions in a way that expedites establishing remote connection sessions between local clients and remote clients. A connection can refer to establishing a communication pathway, the communication pathway being between two or more of a local client, a connection service, or a remote client. A remote client session can refer to a logical relationship—based on a connection—between a local client and a remote client that persists over time and includes multiple interactions and transactions.

By way of illustration, today a connection to a remote client for a local client may take about 10 seconds of wait time or much longer depending on other computing factors. Setting up a connection is based on several connection initialization operations that can include communications with a remote client to configure a connection and a remote client session. In contrast, with express connection management—via a connection management engine—a user or client-initiated remote client session request can leverage a pre-connect connection at a local client to connect to a remote client; leverage an un-finalized connection at a remote client to connect to the remote client; or leverage an existing remote client session at a remote client to connect to the remote client.

The connection management engine operates with limited additional overhead on virtual machines that support the remote clients because the connection management engine is configured to complement existing operations associated with the virtual machines. The connection management engine operates based on a pre-connect connection that is an active lightweight connection at a local client that enables express connection management. In some examples, the pre-connect connection can be kept alive based on a power-saving sleep mode with active ports. The power-saving sleep mode has the local client in a state of reduced power consumption, but certain ports or network components remain operational for maintaining the pre-connect connection.

The connection management engine further splits a remote client session configuration sequence into a first set of operations (i.e., pre-graphics operations) and a second set of operations (i.e., graphics operations and peripheral operations). The remote client session configuration can be associated with authentication, authorization, connection configuration, session brokerage, connection establishment, and/or session initialization. For example, preparing a remote client for user interaction can include setting up user preferences, configuring the remote client's appearance, and launching a shell while executing its startup scripts. Additionally, the remote client session configuration handles user authentication and access rights to ensure a secure and personalized computing experience.

The pre-graphics operations include a subset of operations that can be performed before any graphical elements are rendered or displayed in a user interface. The graphics operations include a subset of operations involved in rendering and displaying graphical elements within a user interface. The peripheral operations are associated with activities or functions performed by peripheral devices. The peripheral operations facilitate initializing, configuring and executing input, output, storage, or communication functions facilitated by peripheral devices connected to a computer. In this way, the pre-graphics operations can be executed to configure an unfinalized connection, while the graphics operations and optionally peripheral operations are subsequently executed, for example, based on a user action to launch a local client interface for the remote client. The un-finalized connections can be generated for multiple local clients at the same time-each associated with a user. The connection management engine can provide for multiple active connections to the same remote client session-either in a full control mode or in a viewing mode.

The technical solution can further be described with by way of example scenarios. For example, when a user, at a local client, initiates a remote client session for a first time, an initial connection is established for the remote client session. The initial connection facilitates providing access to the remote client via the local client. In addition to the initial connection for the remote client session, a pre-connect connection is configured. The pre-connect connection can be configured to run in parallel and stay connected. The pre-connect connection is established as a background connection—via the local client—that operates behind the scenes without direct user interaction or awareness. The pre-connect connection (e.g., pre-connect mode of a local client) supports instant connections for subsequent remote client session requests.

When the local client enters a sleep mode and subsequently wakes up, the connection management engine can operate differently based on the states associated with the local client and the remote client. The connection management engine supports a connected standby mode that includes network connectivity between the local client and remote client; as such, upon waking up, a pre-connect connection can be used to establish a remote client session request after sleep mode. Using the pre-connect connection to establish the remote client session advantageously results in an instant connection upon launching an application that supports the remote client session. In other words, a determination is made whether a pre-connect connection exists, and based on determining that the pre-connect connection exists, a remote logon process is completed to establish a remote client session based on the pre-connect connection.

The connection management engine supports a disconnected standby mode, where a new connection is established for a remote client session. The local client in a disconnected standby mode establishes the new connection that causes a new remote client session to be established—when the local client is not in a connected state and a pre-connect connection does not exist at the local client.

The connection management engine further supports scenarios where a user is connected to a remote client session or remote client from multiple devices (e.g., a first local client and a second local client). A pre-connect connection for a second local client can be employed to instantly connect a user to the second local client from the first client—passing control from the first local client to the second local client. The connection management engine can also support establishing multiple connections from different local clients that are active and connected to the same remote client session. In the event that a remote client session—for a first local client—gets disconnected due to a machine restarting or a network glitch, the connection management engine can retrieve a network context from a second local client to re-establish the remote client session for the first local client.

The connection management resources can include connection management operations that are associated with connection-service-initiated signaling. By way of illustration, in a first scenario, when a remote client session exists on the remote client, but the remote client session is not active, the connection management engine can configure an un-finalized connection associated with the remote client session that exists but is not active. In this way, the user gets to connect to the remote client session.

In a second scenario, where a remote client session exists on the remote client, but the remote client session is active on a first local client and not active on a second local client, the connection management engine can configure an un-finalized connection to the remote client so that the user gets to their remote client session.

In a third scenario, where a remote client session does not exist, the connection management engine can configure an un-finalized connection to a remote client, so that the user can connect to their remote client session.

In a fourth scenario, where a virtual machine is hibernating, the connection management engine can notify a local client when the virtual machine is up and running to initiate a connection automatically—for example—based on the first scenario or the second scenario.

The connection management engine provides graphics-driver management that supports the graphics hardware. Connection management can include graphics driver operations that are employed to optimize performance and maintain monitor layout. The connection management engine can ensure that the graphics driver data and related data or peripheral driver data remains loaded on a virtual machine and avoid any unnecessary reloading. Additionally, the connection management engine can preserve a context of virtual channels and maintain redirections to minimize disruptions. The connection management engine can employ an optimization approach that can prioritize keyboard, mouse, and monitor redirections for enhanced efficiency.

Advantageously, the embodiments of the present technical solution include several inventive features (e.g., operations, systems, engines, and components) associated with a cloud access management system having a connection management engine. The connection management engine supports providing a pre-connect connection that is an active lightweight connection at local clients that enables express connection management; and the connection management engine operates based on a predefined set of operations (e.g., pre-graphics operations, graphics operations, and peripheral operations) that are strategically executed at remote clients to reduce connection times of local clients to remote clients. The connection management resources are a solution to a specific problem (e.g., limitations in instant and timely connections to remote clients and cloud-based resources). The connection management engine can support remote connections and remote client sessions between local clients and remote clients associated with different states including a connected state, an express connection state (i.e., having a pre-connect connection or able to retrieve a cloned network context) and a disconnected state. Moreover, the connection management engine can further support multiple local clients accessing a single remote client session, active and inactive connections to remote clients, different scenarios for local clients, the connection service, and remote clients.

### Example Systems and Resources

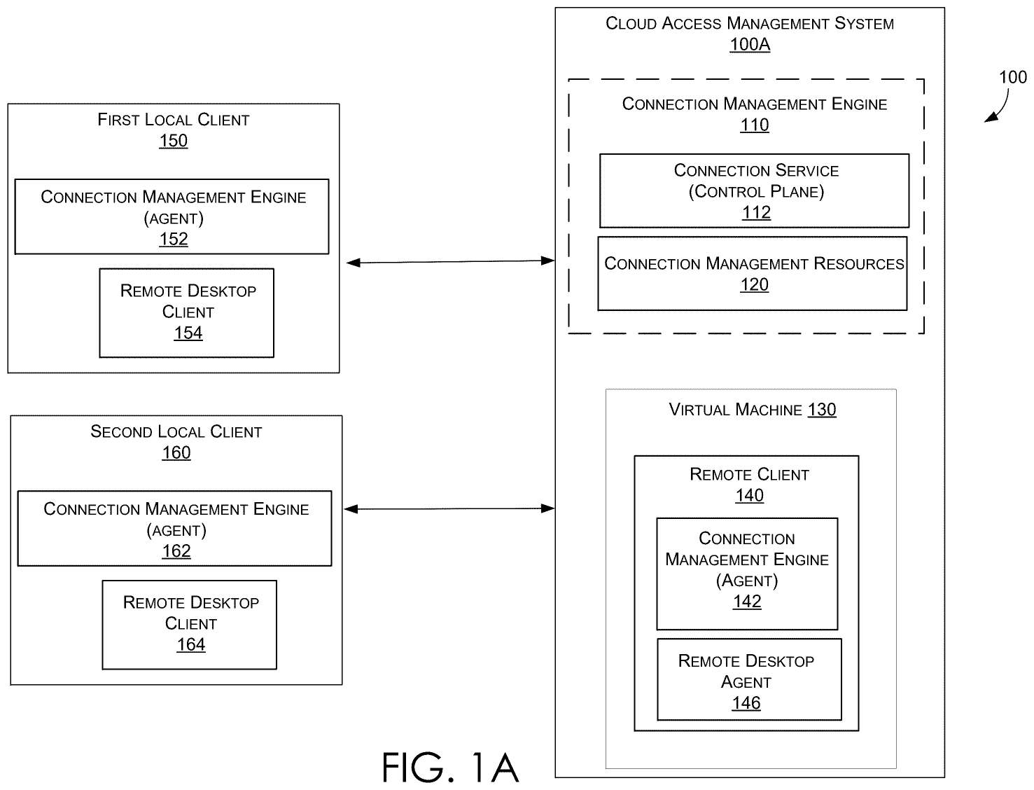

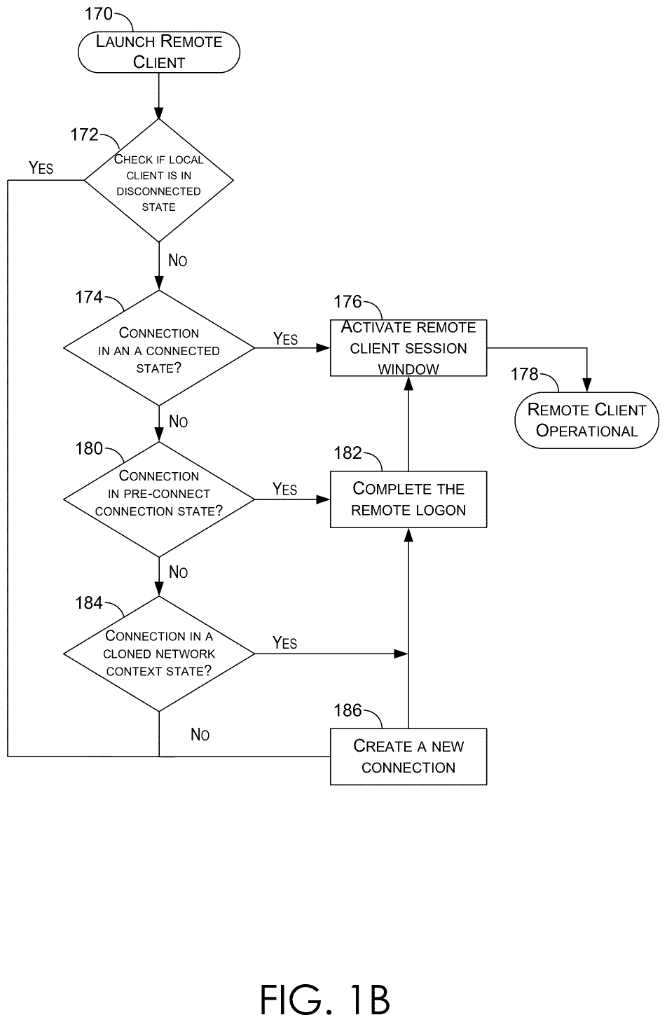

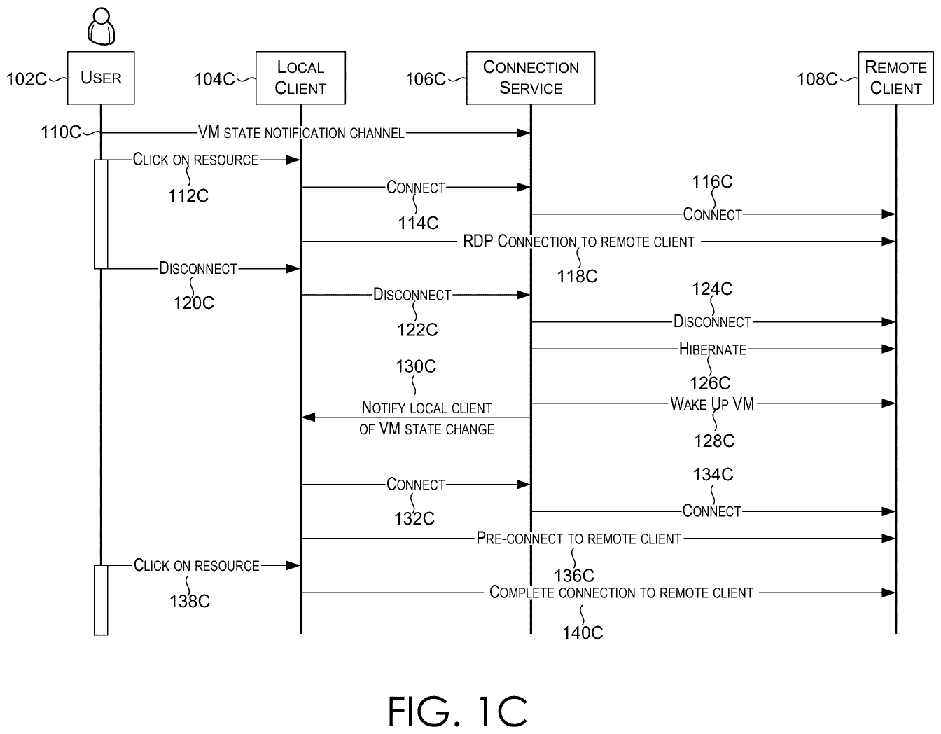

Aspects of the technical solution can be described by way of examples and with reference to FIGS. 1A-1C. FIG. 1A illustrates a cloud computing environment (system) 100, cloud access management system 100A, connection management engine 110, connection service 112, connection management resources 120, virtual machine 130, remote client 140, connection management engine 142, remote desktop agent 146; first local client 150, connection management engine 152, remote desktop client 154; second local client 160, connection management engine 162, and remote desktop client 164.

The cloud access management system 100A provides a centralized platform designed to facilitate secure and efficient access to cloud-based resources (e.g., remote clients). The connection service 112 provides a control plane (e.g., a virtual desktop control plane) that operates as a centralized management and administration infrastructure service that is responsible for managing user sessions, virtual machines, networking, authentication, and other aspects of a virtual desktop environment.

The connection management resources 120 can include operations, interfaces, and data components that support connection management functionality. Operations can include managing sessions, user authentication, resource provisioning, and monitoring. Interfaces are provided to users, administrators, and developers, facilitating access, configuration, and integration tasks. Data components include user profiles, session configurations, application images, virtual machine settings, and logging data, enabling efficient management, security, and compliance with the virtual desktop environment.

Virtual machine 130 is a representative virtual machine (VM) that is provisioned to serve as a session host for users accessing desktops and applications remotely. A VM can run an operating system (e.g., WINDOWS) and is configured with the necessary resources, such as CPU, memory, storage, and network connectivity, to support multiple concurrent user sessions. VMs are managed and maintained to ensure scalability, reliability, and performance for the desktop virtualization environment.

A local client (e.g., first local client 150 or second local client 160) connects to a remote client (e.g., remote client 140) to access cloud-based resources. The local client 150, 160 can include a connection management engine (e.g., connection management engine 152, connection management engine 162) that enables connection management functionality on the local client 150, 160. The local client 150, 160 runs a remote desktop client (e.g., remote desktop client 154, remote desktop client 164) that enables users to access and control a remote client 140. The local client 150, 160 receives a request to launch the remote client 140. The request can be associated with an indication from a user to open or activate a local remote client interface. The connection management engine 152, 162 at the local client 150, 160 determines whether the local client 150, 160 is associated with a connected state, an express connection state, or a disconnected state. The express connection state can refer to any state that supports express connection in that the connection to the remote client 140 is expedited based on one or more connection management operations.

The express connection state is identified from the following: a pre-connect connection state; or a cloned network context state. The pre-connect connected state is associated with a pre-connect connection of the local client 150, 160, the pre-connect connection is an active lightweight connection that enables an express connection between the local client 150, 160 and the remote client 140. The cloned network context state is associated with the local client 150 of a user when a second local client 160 of the user is connected to an existing remote client session. A cloned network context from a second local client 160 enables an express connection between the local client 150 and the remote client 140. When it determined that the local client 150, 160 is associated with the express connection, a remote client session between the remote client 140 and the local client 150, 160 based on the express connection state. For example, the remote client session is based on the pre-connect connection or the cloned network context.

Establishing the remote client session can include communicating a request to complete a remote logon process; and activating a local client interface for the remote client 140. In this way, when the local client 150, 160 is associated with the connected state, the local client interface for the remote client 140 is activated without needing to communicate a request to complete a remote logon process. And when the local client 150, 160 is associated with a disconnected state, the local client 150, 160 communicates a request for a new connection for establishing the remote client session; then communicates a request to complete a remote logon process; and then activates a local client interface for the remote client 140. Moreover, establishing the remote client session is based on a remote logon process associated with a first set of operations that configure an un-finalized connection, and a second set of operations that configures a finalized connection using the un-finalized connection. The first set of operations are pre-graphics operations and the second set of operations are graphics operations. The second set of operation can further include peripheral operations.

It is contemplated that the remote client session can be used to connect a second local client 160 associated with a user of the local client 150, where the local client 150 and the second local client 160 are simultaneous active connections to the remote client session. The local client 150 or the second local client 160 is simultaneously connected to the remote client session in full control mode, viewing mode, or pre-connect mode.

The connection service 112 enables hosting remote client sessions on session hosts (e.g., virtual machine 130) with secure endpoints for client-session host connections. The remote client 140 connects to a local client 150, 160 via a remote connection associated with the remote client session. The connection service 112 and/or the remote client 140 support connection management. In particular, the remote client 140 includes the connection management engine 142 and remote desktop agent 144 associated with connection management operations. The connection management engine 142 determines a status associated with a remote client 140; based on determining the status, the connection management engine 142 execute one or more connection management operations, the one or more connection management operations configure an un-finalized connection using a first set of operations. The first set of operations are associated with a second set of operations that configure a finalized connection using the un-finalized connection; the first set of operations are pre-graphics operations and the second set of operations are graphics operations. Based on executing the one or more connection management operations, the remote client 142 establishes a remote client session between a remote client 140 and a local client 150, 160.

The status of the remote client 140 indicates how the un-finalized connection is configured. The status is identified from one of the following: an existing remote client session that is not active; an existing remote client session that is active on an alternate local client; and no existing remote existing remote client session. The un-finalized connection is configured for the remote client session based on the status indicating the remote client session exists and not active. The un-finalized connection is configured for the remote client based on the status indicating the remote client exists and is active on the alternate local client. The un-finalized connection is configured for the remote client based on the status indicating that no remote client session exists.

The connection service 112 can support additional connection management operations that including determining that a virtual machine 130 associated with the remote client 140 is hibernating; and communicating a notification to the local client 150, 160 to initiate a connection automatically. The connection service 112 can further facilitate retaining graphics driver data and related data or peripheral driver data on virtual machines that support remote clients; and preserve virtual channels that maintain redirections associated with remote client sessions.

With reference to FIG. 1B, FIG. 1B illustrates example scenarios associated with user and local-client signaling for express connection management. Initially, at step 170, a request to launch a remote client at a local client, is received. At step 172, a determination is made whether the local client is in a disconnected state. Based on determining the local client is not in a disconnected state; at 174, a determination is made whether the connection is in a connected state with an inactive local client—in other words, whether local client is active or inactive and whether the remote client session already exists. At step 174, based on determining that the local client is an inactive local client with a remote client session that exists, at step 176, the remote client session window is activated; and at step 178 the remote client is operational.

Alternatively, at step 174, a determination can be made that the local client is not in a connected state. At step 180, based on determining that the connection is not in a connected state, a determination is made whether a pre-connect connection exists. At step 182, based on determining that the pre-connect connection exists, a remote logon process is completed. Upon completing the remote logon process, at step 176, the remote client session window is activated; and at step 178 the remote client is operational.

Alternatively, at step 180, a determination can be made the local client is not in a pre-connect connection state. At step 184, based on determining that the pre-connect connection does not exist, a determination is made whether the local client is in a cloned network context state (i.e., a network context from another local client exists). When a network context exists on another local client, a cloned network state is retrieved from the other local client and the remote logon process is completed. As shown, at step 182, based on determining that a network context exists, a remote logon process is completed. Upon completing the remote logon process, at step 176, the remote client session window is activated; and at step 178 the remote client is operational.

Alternatively, at step 172, a determination can be made that the local client is in a disconnected state, or at 184, a determination can be made that a cloned network context state does not exist. At step 186, based on determining that the local client is disconnected; or based on determining a network context does not exist; a new connection is created to initialize a remote client session. At step 182, a remote logon process is completed; at step 176, the remote client session window is activated; and at step 178 the remote client is operational.

With reference to FIG. 1C, FIG. 1C illustrates an example scenario associated with communications for express connection management. At step 110C, a virtual machine state notification channel is established. At step 112C, a user 102C initiates (e.g., via a click on resource) a remote connection from local client 104C to the remote client 108C—via connection service 106C. At step 114C, the local client 104C communicates a request to establish a connection for a remote client session with a remote client 108C. At block 116C, the connection service 106C communicates the request to establish the connection for the remote client session to the remote client 108C. At block 118C, the local client 104C and the remote client 108C establish the connection and the remote client session (e.g., remote desktop protocol (RDP) connection to remote client 108C). At block 120C, the user communicates an indication to disconnect from the remote client 108C. At block 122C, the local client 104C communicates a request to disconnect the remote client session from the remote client 108C. At block 124C, the connection service 106C communicates the request to disconnect the remote client session. At block 126C, the connection service 106C communicates a request for the remote client 108C to enter a hibernate mode.

At block 128C, the connection service 106C communicates a request for the remote client 108C to wake up (e.g., in response to activity at the local client, based on an anticipated logon time of the user, or based on a predefined administrator configuration to wake up the remote client). At block 130C, the connection client 106C notifies the local client of the state change of the remote client 108C from hibernate mode to wake up mode. At block 132C, the local client 104C communicates a request for a connection to establish a remote client session with the remote client 108C. At block 134C, the connection service 134C communicates the request for the connection to establish the remote client session. At block 136C, the local client 104C and the remote client 108C establish a pre-connect connection. At block 138C, a user initiates (e.g., via a click on resource) a remote connection from local client. At block 140C, based on the pre-connect connection the local client 104C establishes a connection and a remote connection session with the remote client 108C.

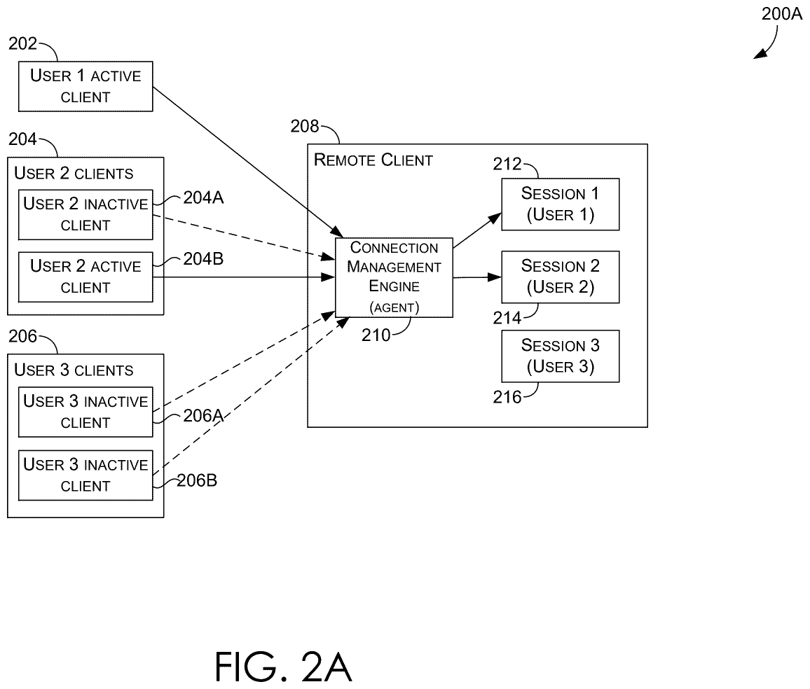

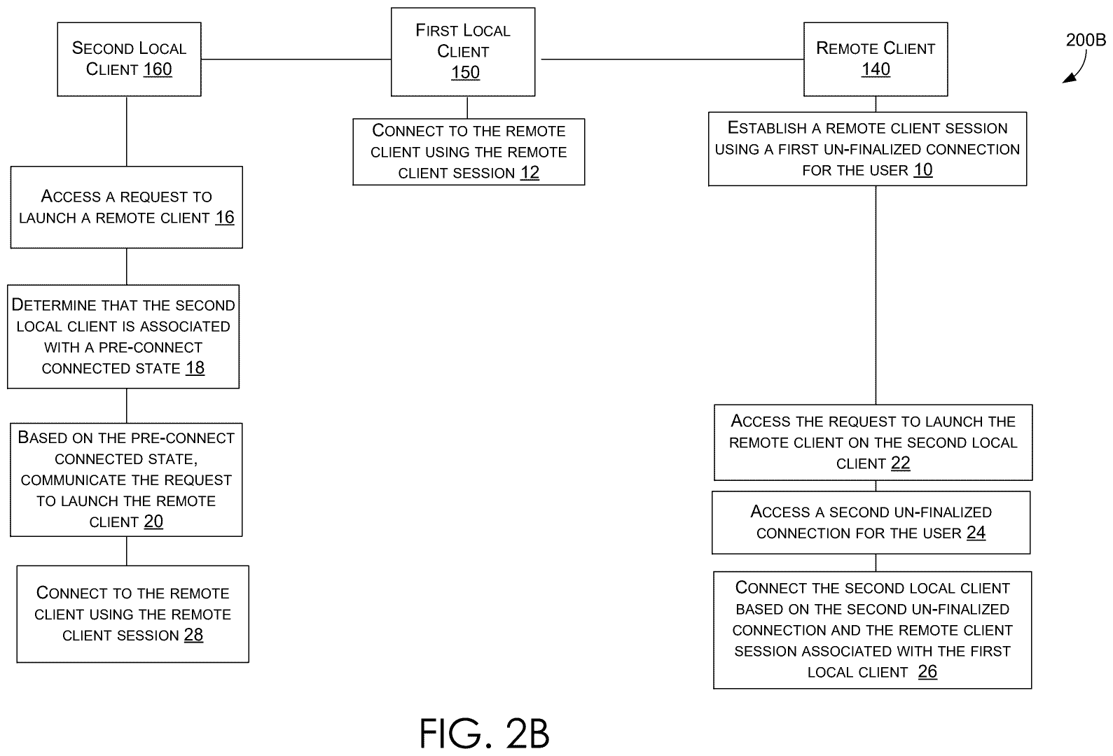

With reference to FIG. 2A, FIG. 2A illustrates cloud computing environment 200A with example scenarios for multiple users, local clients, active and inactive connections to remote clients, and connection management using a remote client. FIG. 2A includes connection management engine 210 that connects user 1 active client 202, user 2 clients 204 (i.e., user 2 inactive client 204A and user 2 active client 204B) and user 3 clients 206 (i.e., user 3 inactive client 206A and user 3 inactive client 206B) to corresponding sessions (i.e., session 1 212, session 2 214, and session 3 216 respectively). By way of context, a connection refers to a communication link between a local client and a remote client. Being connected means that the local client has established a communication link with the remote client. Being active means that a connected local client is actively sending, receiving, or processing data with the remote client. An active local client can be powered on and ready to execute commands. A local client can be inactive, but still connected to an existing session. For example, a user of the local client may establish a session with a remote client, but if there is no activity or interaction occurring within the session for a period of time, the local client may go into an inactive state. A local client that becomes inactive on an existing session can be reactivated on the session (e.g., via a request to reactivate the local client that was inactive, but still connected). In this way, a connected state can describe two different types of connected states—a connected state with an active local client or a connected state with an inactive local client. In both situations, a remote client session exists, and if the local client is an inactive local client, the local client can be reactivated on the remote client session that exists. The active local client may not have an activated remote client session window, which can be activated after determining a connection exists, and the local client is active, but without the activated remote session window.

The connection management engine 210 supports scenarios where a user is connected to a remote client session from a single device (e.g., user 1) or multiple devices (e.g., user 2 and user 3). User 1 active client 202 is active on session 1 212. User 2 inactive client 204A is inactive and user 2 active client 204B is active, both connected to session 2 214. And, user 3 inactive client 206A and user 3 inactive client 206B are both inactive and connected to session 3 216.

The connection management engine 210 can also establish multiple connections from different local clients that are active and connected to the same remote client session. For example, user 2 inactive client 204A can be reactivated on session 2, such that user 2 inactive client 204A becomes active. In this way, user 2 clients 204 can both be active on session 2 214. In the event that a remote client session—for a first local client—gets disconnected due to a machine restarting or a network glitch, the connection management engine 210 can retrieve a network context from a second local client to connect to establish the remote client session for the first local client.

With reference to FIG. 2B, FIG. 2B illustrates a cloud computing system 200B having remote client 140, first local client 150, and second local client 160. At block 10, the remote client 140 establishes a remote client session using a first un-finalized connection for the user. At block 12, the first local client 150 connects to the remote client 150 using the remote client session. At block 16, second local client 160 accesses a request to launch a remote client; at block 18, determines that the second local client 160 is associated with a pre-connect connected state; and at block 20, based on the pre-connect connected state, communicates the request to launch the remote client.

At block 22, the remote client 140 accesses the request to launch the remote on the second local client 160; at block 24, accesses a second un-finalized connection for the user; and at block 26, connects to the second local client 160 based on the second un-finalized connection and the remote client session. At block 28, the second local client 160 connects to the remote client using the remote client session.

### Example Methods

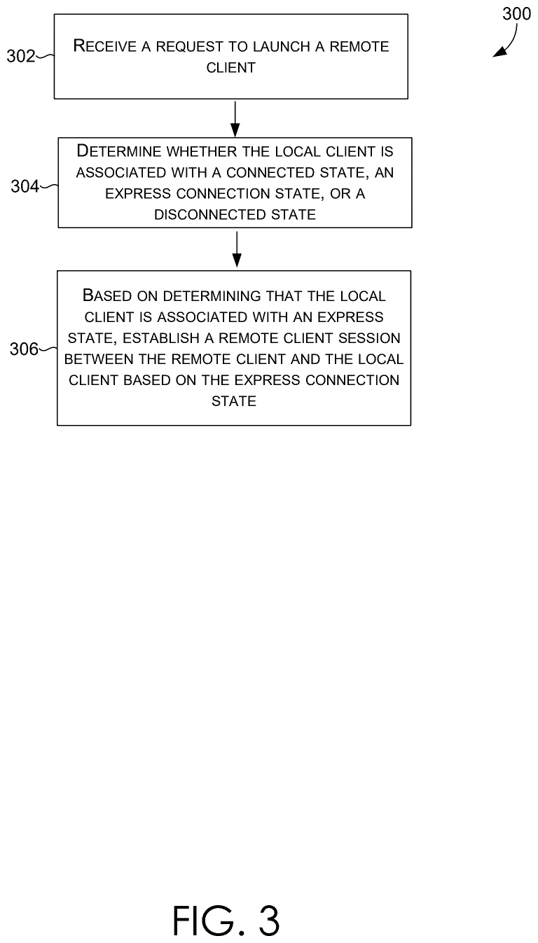

With reference to FIGS. 3, 4, and 5, flow diagrams are provided illustrating methods for providing express connection management using a connection management engine in a cloud access management system. The methods may be performed using the cloud access management system described herein. In embodiments, one or more computer-storage media having computer-executable or computer-useable instructions embodied thereon that, when executed, by one or more processors can cause the one or more processors to perform the methods (e.g., computer-implemented method) in the cloud access management system (e.g., a computerized system).

Turning to FIG. 3, a flow diagram is provided that illustrates a method 300 for providing connection management using a connection management engine in a cloud access management system. At block 302, receive a request to launch a remote client. At block 304, determine whether the local client is associated with a connected state, an express connection state, or a disconnected state. At block 306, establish a remote client session between the remote client and the local client based on the express connection state.

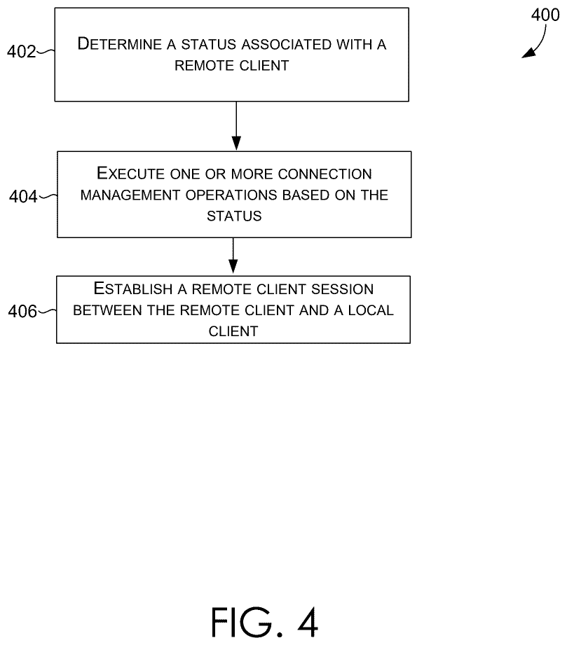

Turning to FIG. 4, a flow diagram is provided that illustrates a method 400 for providing connection management using a connection management engine in a cloud access management system. At block 402, determine a status associated with a remote client. At block 404, execute one or more connection management operations. At block 406, establish a remote client session between the remote client and a local client.

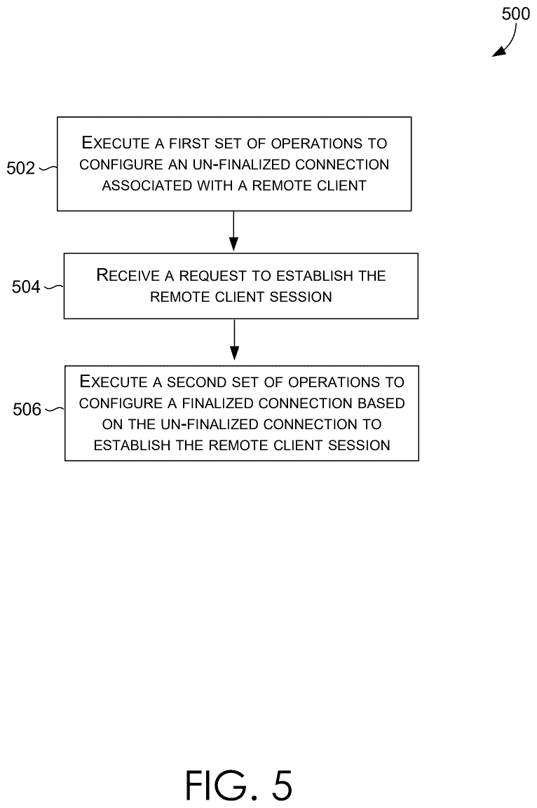

Turning to FIG. 5, a flow diagram is provided that illustrates a method 500 for providing connection management using a connection management engine in a cloud access management system. At block 502, execute a first set of operations to configure an un-finalized connection associated with a remote client. At block 504, receive a request to establish the remote client session. At block 506, execute a second set of operations to configure a finalized connection based on the un-finalized connection to establish the remote client session.

### Technical Improvement

Embodiments of the present techniques have been described with reference to several inventive features (e.g., operations, systems, engines, and components) associated with a cloud access management system. Inventive features described include: operations, interfaces, data structures, and arrangements of computing resources associated with providing the functionality described herein relative with reference to a connection management engine. Functionality of the embodiments of the present invention have further been described, by way of an implementation and anecdotal examples—to demonstrate that the operations for providing the connection management engine as a solution to a specific problem in device management technology to improve computing operations in cloud access management systems.

By way of example, the connection management engine supports providing a pre-connect connection that is an active lightweight connection at a local client that enables express connection management; and the connection management engine operates based on a predefined set of operations (e.g., pre-graphics operations, graphics operations, and peripheral operations) that are strategically executed at remote clients to reduce connection times of local clients to remote clients. The connection management engine can support remote connections and remote client sessions between local clients and remote clients associated with different states including a connected state, an express connection state (i.e., having a pre-connect connection or able to retrieve a cloned network context) and a disconnected state. Moreover, the connection management engine can further support multiple local clients accessing a single remote client session, active and inactive connections to remote clients, different scenarios for local clients, the connection service, and remote clients.

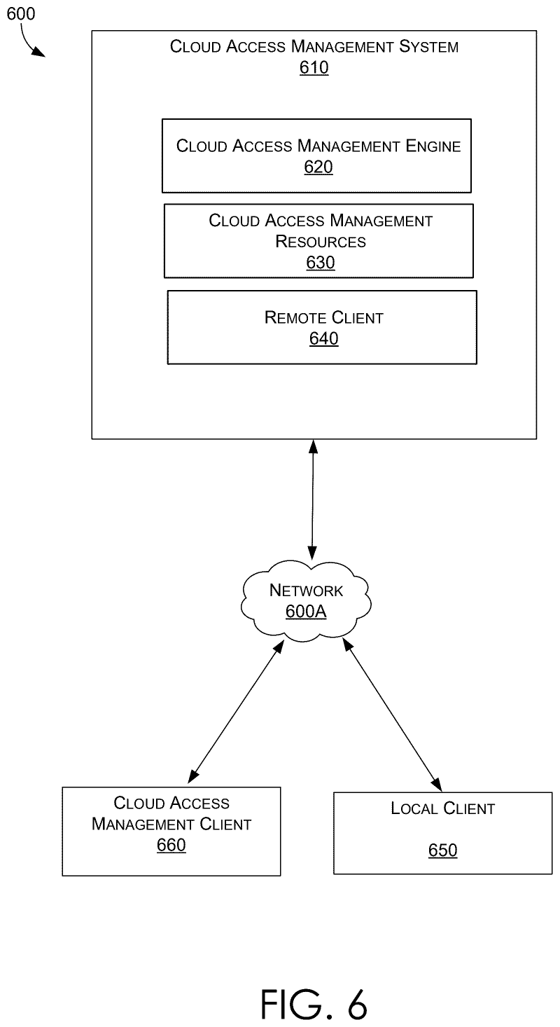

Aspects of the technical solution have been described by way of examples and with reference to FIGS. 1A, 1B, 1C, 2A and 2B. FIG. 1A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

### Additional Support for Detailed Description

### Example Cloud Access Management System in a Computing Environment

Referring now to FIG. 6, FIG. 6 illustrates a computing environment in which implementations of the present disclosure may be employed. In particular, FIG. 6 shows a high level architecture of an example cloud computing platform 600 and cloud access management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services—including compute, servers, storage, databases, networking, and intelligence. The components of cloud computing environment 600 may communicate with each other over a network 600A which may include, without limitation, one or more local area networks (LANs) and/or wide area networks (WANs).

The cloud access management system 610 provides cloud access management functionality for different types of cloud computing offerings. The cloud access management system can be a centralized platform designed to facilitate secure and efficient access to cloud-based resources from various devices, including traditional desktops, laptops, and thin clients. The cloud access management system can include software, hardware, and infrastructure components that enable users to authenticate, connect, and interact with remote resources hosted in the cloud. The cloud access management system manages operations associated with user identities, permissions, and access policies to ensure that only authorized users can access specific resources. Additionally, it may incorporate features such as single sign-on (SSO), multi-factor authentication (MFA), and session management to enhance security and user experience.

Cloud access management system 610 enables secure and efficient access for local clients to remote resources, such as remote clients, through a centralized platform. It encompasses authentication mechanisms to verify the identities of users and devices seeking access, including multi-factor authentication for enhanced security. Authorization protocols govern user permissions and access levels, dictating which resources or applications each user can utilize. Session management functionalities handle the establishment, monitoring, and termination of user sessions, optimizing performance while ensuring compliance with security policies. The cloud access management system also manages connections between local clients and remote clients, employing robust encryption and data integrity measures to protect sensitive information during transmission.

The cloud access management system 610 includes a cloud access management engine 620 that is a computing environment that supports executing computational tasks associated with the cloud access management system 610. The cloud access management engine 620 can be a hardware or software component that performs computational operations, such as, mathematical calculations, data processing, and algorithm execution. The cloud access management system 610 integrates cloud access management resources 630 into cloud access management system 610 to effectively provide cloud access management in a computing environment.

The cloud access management resources 630 refer to computing elements (e.g., components, capability, or entities) that collectively enable the cloud access management engine 620 operations. The cloud access management resources 630 encompass a spectrum of computing elements, beginning with the diverse operations the cloud access management resources 630 can perform, ranging from complex computations to data manipulations. Interfaces, an integral part of the cloud access management resources 630, provide the means for both user interaction and seamless integration with external systems, ensuring a dynamic and interactive computing experience. The data facet of the cloud access management resources 630 involves various types: input data, which is the information provided for processing; processing data, representing the data manipulated during computational tasks; and output data, the results generated by the cloud access management engine 620. In this way, the cloud access management resources 630 support the broader cloud access management engine 620 and cloud access management system 610.

The cloud access management resources can include connection management resources that encompass the core operations, interfaces, and data components within cloud access management system 110, collectively supporting its functionality in overseeing diverse devices across the cloud computing system 100. Operations within the connection management engine 110 include connection establishment, authentication, session management, error handling, logging, and monitoring, ensuring seamless user experiences and optimal resource utilization. Interfaces, including graphical user interfaces, command-line interfaces, web-based portals, APIs, and integration points, facilitate initiating and managing connections while enabling programmatic interaction and integration with other systems. Data components consist of connection profiles, session data, access control lists, performance metrics, and security keys are meticulously managed to ensure data integrity, confidentiality, and availability. The connection management resources 120 facilitate seamless, secure, and efficient communication between local clients and remote clients, enabling users to access cloud resources with reliability and ease.

The cloud access management system 610 provisions remote clients (e.g., remote client 640). A remote client 640 can be virtual desktop environment (e.g., Desktop as a Service—DaaS). The remote client 640 leverages virtualization, cloud computing, and network technologies to deliver scalable, secure, and cost-effective virtual desktop environments to users, enabling flexible remote access to computing resources from any location, on any device. DaaS providers provide Virtualized Desktop Infrastructures (VDI) that host virtual desktops on servers in their data centers. These virtual desktops are created using virtualization technologies such as hypervisors or containerization platforms. Each virtual desktop includes an operating system, applications, data, and user settings.

The local client 650 connects to the remote client 640. The local client 650 can be a software application or device installed or used on the end-user's local hardware, such as a desktop computer, laptop, thin client, or mobile device. This client software facilitates the remote connection to the VDI hosted by the remote client provider, allowing end-users to access their virtual desktop environments over the internet. Local client 650 can be a managed client that is centrally controlled and monitored by cloud access management system 610. Managed clients typically have device management software installed or configured on them, allowing administrators to enforce security policies, configure settings, deploy applications, and perform remote management tasks. The local client 650 can be an unmanaged client that operates independently without being centrally controlled or monitored. These devices lack device management software or configurations, and users have full control over their settings and applications.

The cloud access management client 660 supports access to cloud access management system 610. Cloud access management client 660 provides a graphical or command-line interface for users or administrators to monitor and manage user sessions to ensure proper termination, timeout, and session activity logging. Configuring authentication methods such as passwords, multi-factor authentication (MFA), biometrics, or single sign-on (SSO) to verify user identities, and setting up authorization rules and permissions to govern user access to specific resources, applications, or data. The cloud access management client 660 supports centralized access management within a computing environment empowering efficient access administration.

### Example Distributed Computing System Environment

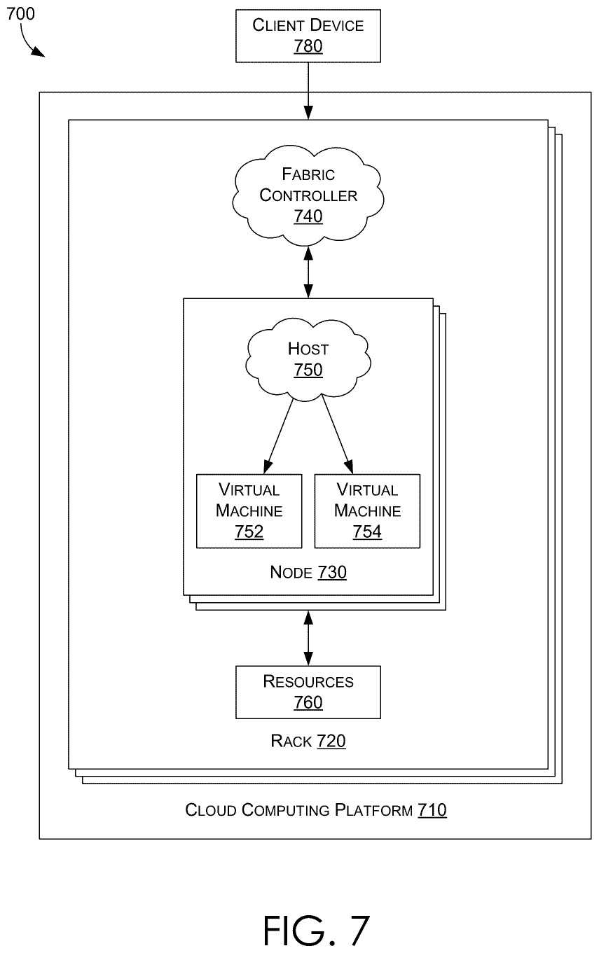

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

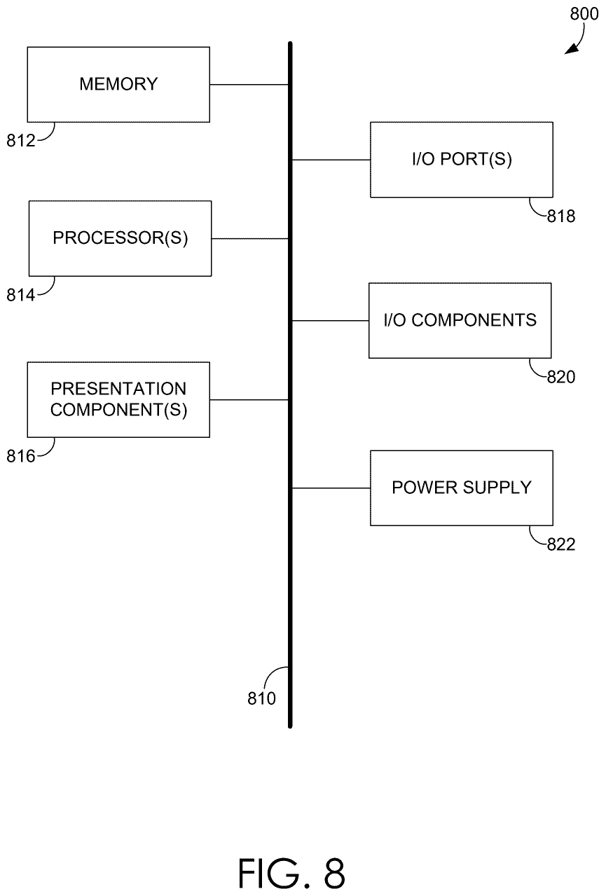

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
receiving a request to launch a remote client, the request associated with a local client;
determining whether the local client is associated with a connected state, an express connection state, or a disconnected state, wherein the express connection state is identified from the following: a pre-connect connection state or a cloned network context state; and
based on determining that the local client is associated with the express connection state, establishing a remote client session between the remote client and the local client based on the express connection state.

2. The system of claim 1, wherein establishing the remote client session comprises:
communicating a request to complete a remote logon process; and
activating a local client interface for the remote client.

3. The system of claim 1, the operations further comprising:
determining that the local client is associated with the connected state; and
activating the local client interface for the remote client without communicating a request to complete a remote logon process.

4. The system of claim 1, the operations further comprising:
determining that the local client is associated with a disconnected state;
communicating a request for a new connection for establishing the remote client session;
communicating a request to complete a remote logon process; and
activating a local client interface for the remote client.

5. The system of claim 1, wherein the pre-connect connected state is associated with a pre-connect connection of the local client, the pre-connect connection is an active lightweight connection that enables an express connection between the local client and the remote client.

6. The system of claim 1, wherein the cloned network context state is associated with the local client of a user when a second local client of the user is connected to an existing remote client session,
wherein a cloned network context from the second local client enables an express connection between the local client and the remote client.

7. The system of claim 1, wherein establishing the remote client session is based on a remote logon process associated with a first set of operations that configure an un-finalized connection and a second set of operations that configure a finalized connection using the un-finalized connection, wherein the first set of operations are pre-graphics operations and the second set of operations are graphics operations.

8. The system of claim 1, wherein the remote client session is used to connect a second local client associated with a user of the local client, wherein the local client and the second local client are simultaneous active connections to the remote client session.

9. The system of claim 8, wherein the local client or the second local client is simultaneously connected to the remote client session in full control mode, viewing mode, or pre-connect mode.

10. One or more computer-storage media having computer-executable instructions embodied thereon that, when executed by a computing system having a processor and memory, cause the processor to perform operations, the operations comprising:
determining a status associated with a remote client;
based on determining the status, executing one or more connection management operations, the one or more connection management operations executed to configure an un-finalized connection using a first set of operations, the first set of operations associated with a second set of operations that configure a finalized connection using the un-finalized connection, wherein the first set of operations are pre-graphics operations and the second set of operations are graphics operations; and
based on executing the one or more connection management operations, establishing a remote client session between the remote client and a local client.

11. The media of claim 10, wherein the status is identified from one of the following: an existing remote client session that is not active; an existing remote client session that is active on an alternate local client; and no existing remote existing remote client session.

12. The media of claim 10, wherein the un-finalized connection is configured for the remote client session based on the status indicating the remote client session exists and not active.

13. The media of claim 10, wherein the un-finalized connection is configured for the remote client based on the status indicating the remote client exists and is active on the alternate local client.

14. The media of claim 10, wherein the un-finalized connection is configured for the remote client based on the status indicating that no remote client session exists.

15. The media of claim 10, the operations further comprising:
determining that a virtual machine associated with the remote client is hibernating; and
communicating a notification to the local client to initiate a connection automatically.

16. The media of claim 10, wherein the one or more connection management operations further comprise:
retaining graphics driver data and peripheral driver data on virtual machines that support remote clients; and
preserving virtual channels that maintain redirections associated with remote client sessions.

17. A computer-implemented method, the method comprising:
executing a first set of operations to configure an un-finalized connection associated with a remote client, the first set of operations being pre-graphics operations associated with a remote client session configuration sequence that enables establishing a remote client session between the remote client and a local client;
receiving a request to establish the remote client session; and
based on receiving the request to establish the remote client session, executing a second set of operations to configure a finalized connection based on the un-finalized connection to establish the remote client session, the second set of operations being graphics operations associated with the remote client session configuration sequence.

18. The method of claim 17, wherein the second set of operations further comprise peripheral operations.

19. The method of claim 17, the operations further comprising:
executing the first set of operations to configure a second un-finalized connection associated a user, wherein the un-finalized connection and the second un-finalized connection are associated with user; and
connecting to a second client using the second un-finalized connection and the remote client, wherein the local client and the second local client are simultaneous active connections to the remote client session.

20. The method of claim 19, wherein the local client or the second local client is simultaneously connected to the remote client session in full control mode, viewing mode, or pre-connect mode.
